(19) United States
(12) Patent Application Publication
(10) Pub. No.: US 2015/0245197 A1
(43) Pub. Date: Aug. 27, 2015

(54) PORTABLE TERMINAL ENABLING CONTROL OF SIM CARD AND METHOD FOR CONTROLLING THE PORTABLE TERMINAL

(71) Applicant: Chulhee Lee, Seoul (KR)

(72) Inventor: Chulhee Lee, Seoul (KR)

(21) Appl. No.: 14/185,943

(22) Filed: Feb. 21, 2014

(51) Int. Cl. H04W 8/20; H04W 76/02

(52) U.S. Cl. CPC H04W 8/205; H04W 76/023

(57) ABSTRACT

Disclosed are apparatus and methods for controlling SIM cards. An apparatus which is paired with a second terminal comprises: a SIM card; state checking means which checks the state of the paired terminal with identical identification information as the first SIM card; and activation control means which controls SIM card activation depending on the state of the paired terminal. Using this configuration, the present invention makes it possible for a user to maintain multiple terminals using the same phone number with one billing statement without the help of a service provider through SIM card control.

### CROSS-REFERENCE TO RELATED APPLICATIONS

This application claims priority to and the benefit of Korean Patent Application No. 10-2013-0019404 filed in the Korean Intellectual Property Office on Feb. 22, 2013, the entire contents of which are incorporated herein by reference.

### TECHNICAL FIELD

The present invention relates to mobile terminals, and more particularly, to a mobile terminal that provides identification information through a SIM (Subscriber Identification Module) card.

### BACKGROUND ART

Recently, the mobile phone market has been rapidly changing and smartphones, which support voice communications, data communications and various other applications, have become mainstream devices.

Along with the growth of smartphones, the tablet PC has also grown rapidly. The number of users who possess various types of smartphones or tablet PCs is rapidly increasing.

Also, as the life cycle of smartphone decreases, the case that a user owns several smartphones with purchase of new smartphones is rapidly increasing.

Although these users increasingly own several smartphones, it is difficult to utilize all these phones since they each require separate phone numbers. In particular, through upgrading, a user may own several smartphones with diverse sizes and functionalities.

On the other hand, all mobile devices, including smartphones, include SIM cards, which recognize subscribers and provide identification information for billing purposes.

Traditionally, every smartphone has a SIM card with different identification information and with a different phone number. Consequently, this makes efficient management difficult for a user who manages several smartphones.

Although techniques that allow multiple smartphones to use the same phone number have been proposed, these methods require special processing and they are difficult to implement without the involvement of service providers.

### SUMMARY OF THE INVENTION

The present invention provides mobile terminals and control methods thereof so that a user can use multiple mobile terminals with the same phone number. Also, by controlling the SIM cards of mobile terminals, the present invention provides mobile terminals and control methods thereof so that the user can use a single phone number without the need to involve their service providers.

To accomplish the aforementioned goal, an exemplary embodiment of the present invention provides a terminal that has SIM card, state checking means that checks the state of a paired terminal with identical identification information as the SIM card, and SIM card activation control means that activates the SIM card based on the state of the paired terminal.

The SIM card activation control means activates the SIM card when the SIM card of the paired terminal is deactivated.

The terminal can additionally include communication means that can transmit messages to the paired terminal and receive messages from the paired terminal.

The terminal can additionally include auxiliary information transmission means that can send auxiliary information to the paired terminal.

When the SIM card of the paired terminal is activated, the communication means sends a deactivation control message to the paired terminal, and the state checking means verifies the deactivation of the paired terminal and then activates the SIM card.

When the state of the paired terminal is unknown, the communication means sends a state report request message requesting the state report of the paired terminal to the paired terminal.

The auxiliary information transmission means sends auxiliary information when the terminal's SIM card is to be deactivated or the terminal is to be turned off and the paired terminal is turned on or the paired terminal's SIM card is to be activated. By retaining the transmission history of the auxiliary information, only the auxiliary information that has not been sent to the paired terminal is transmitted.

The communication means transmits a state message about the SIM card deactivation to the paired terminal when a SIM card deactivation command or a power-off command is received.

The communication means sends the message to a server that can transfer it to the paired terminal and the server transfers the message to the paired terminal.

The SIM card is a rewritable SIM card and the received identification information is written to the rewritable SIM card.

The terminal reads the SIM card identification information and sends it to the paired terminal.

Another exemplary embodiment of the present invention provides a method for controlling terminals, comprising: (a) checking the state of the paired terminal with the same identification information as that of the SIM card of the terminal; and (b) activating the SIM card based on the state of the paired terminal.

Another exemplary embodiment of the present invention provides memory means that stores programs needed to execute the aforementioned methods and programs that can be read by digital data processing units.

Another exemplary embodiment of the present invention provides a terminal set, comprising: a first terminal with a first SIM card; and a second terminal with a second SIM card that has the same identification information as the first terminal and activates the second SIM card based on the state of the first SIM card.

The present invention has the advantage that multiple terminals can be managed with a single phone number through controlling the SIM cards. Thus, single-number billing is possible.

### BRIEF DESCRIPTION OF THE DRAWINGS

FIG. 1 illustrates how mobile terminals operate according to an exemplary embodiment of the present invention.

FIG. 2 illustrates the message transmission and reception between mobile terminals according to an exemplary embodiment of the present invention.

FIG. 3 illustrates the message transmission and reception between mobile terminals according to another exemplary embodiment of the present invention.

FIG. 4 illustrates the modules of the mobile terminal according to an exemplary embodiment of the present invention.

FIG. 5 is a first diagram illustrating how the SIM card of the mobile terminal is activated according to an exemplary embodiment of the present invention.

FIG. 6 is a second diagram illustrating how the SIM card of the mobile terminal is activated according to an exemplary embodiment of the present invention.

FIG. 7 is a third diagram illustrating how the SIM card of the mobile terminal is activated according to an exemplary embodiment of the present invention.

FIG. 8 is a diagram illustrating how auxiliary information is transmitted to the paired terminal according to the exemplary embodiment of the present invention.

FIG. 9 illustrates how the mobile terminals utilize the wireless link between a station and the paired terminal according to an exemplary embodiment of the present invention.

FIG. 10 illustrates an example of the interface that is provided when the state of the paired terminal is unknown.

FIG. 11 shows a flowchart for the procedure requesting the second mobile terminal to deactivate its SIM card using a third terminal when the first mobile terminal cannot directly communicate with the second mobile terminal.

FIG. 12 is another illustration of FIG. 11.

### DETAILED DESCRIPTION

Considering that the present invention can be modified in various ways and has various embodiments, specific exemplary embodiments will be illustrated and described in detail with figures. It is not intended to limit the present invention to the specific embodiments, but the present invention should be understood to include all modifications, equivalent means and substitutes according to the ideas and teachings of the present invention. In explaining the figures, similar reference numbers are used to describe equivalent elements.

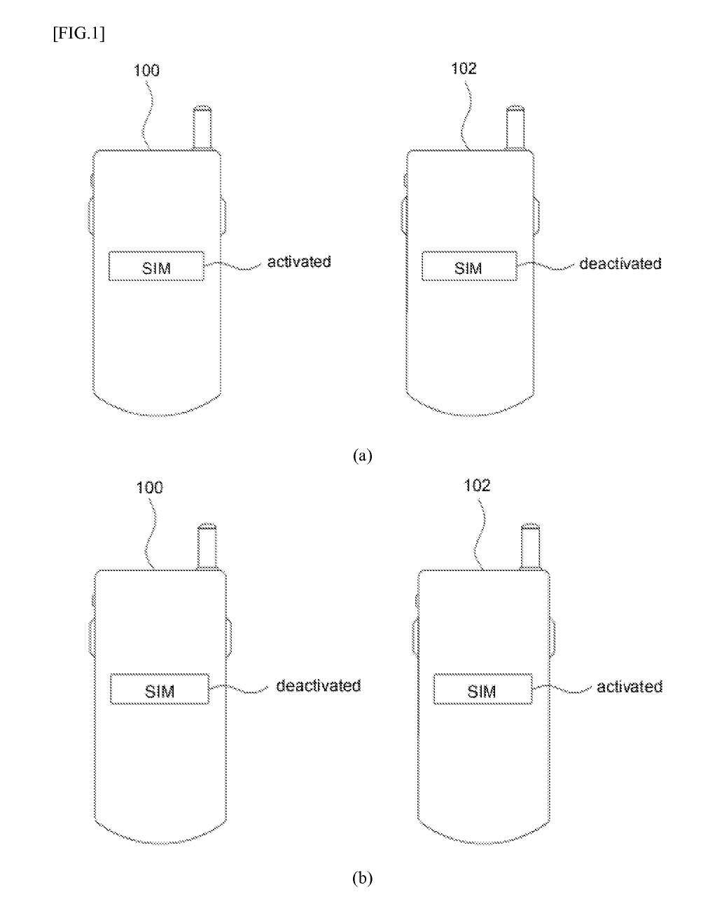

FIG. 1 illustrates how mobile terminals operate according to an exemplary embodiment of the present invention. Referring to FIG. 1, there are two mobile terminals (100, 102), which are used by the same user and have SIM cards that have the same identification number. In other words, the first mobile terminal (100) and the second mobile terminal (102) have identical SIM cards and use the same phone number, and the billing information is the same.

It is possible to produce several SIM cards with the same identification number. Alternatively, by using rewritable SIM cards and a SIM card reader, it is also possible to read the information when a SIM card is inserted into the SIM card reader and then write the information to rewritable SIM cards.

It is possible to implement a rewritable SIM card using the memory of the mobile terminal. In other words, after reading or receiving the SIM card identification information, it can be stored in the memory of the terminal and can be used to communicate with a telecommunication company.

The first mobile terminal (100) and the second mobile terminal (102) can communicate with stations to receive telecommunication services such as 3G, LTE, 4G, etc., and include mobile terminals such as smartphones, tablet PCs, etc.

The SIM card is used to identify the user's terminal and records the billing information. In general, every mobile terminal uses a different SIM card.

If two terminals used by the same user contain different SIM cards, each terminal is recognized as a separate phone number and billing is done separately for each phone.

Considering that it is not easy for users to maintain two different phone numbers, the present invention provides mobile terminals that can be selectively used depending on the need.

On the other hand, when two mobile terminals use the identical SIM card, their SIM cards should be not activated simultaneously. Thus, in the present invention, the mobile terminal first checks the condition to see whether it can activate the SIM card and then activates the SIM card.

As illustrated in FIG. 1, among the two mobile terminals (100, 102), only one terminal's SIM card is activated. When a mobile terminal's SIM card is to be activated, the paired terminal's SIM card should be in an inactive state.

As illustrated in FIG. 1(a), when the SIM card of the first mobile terminal (100) is activated, the SIM card of the second mobile terminal (102) is deactivated. As illustrated in FIG. 1(b), when the SIM card of the second mobile terminal (102) is activated, the SIM card of the first mobile terminal (100) is deactivated.

Deactivation of the SIM card can be performed by turning off the mobile terminal. It is also possible to deactivate the SIM card while the mobile terminal is turned on. Here, the mobile terminal can send a power-off message to the telecommunication company and terminate all communications with the company. Although all communications are terminated with the telecommunication company, the mobile terminal still can connect the internet, etc.

The first mobile terminal (100) and the second mobile terminal (102) check the state of the paired terminal and then activate the SIM card. In other words, each terminal activates its SIM card after first checking whether the SIM card of the paired terminal is deactivated.

As illustrated in FIG. 1(a), when the SIM card of the first mobile terminal (100) is to be activated, the first mobile terminal (100) checks whether the SIM card of the second mobile terminal (102) is deactivated, and then activates the SIM card of the first mobile terminal (100). Also, as illustrated in FIG. 1(b), when the SIM card of the second mobile terminal (102) is to be activated, the second mobile terminal (102) checks whether the SIM card of the first mobile terminal (100) is deactivated and then activates the SIM card of the second mobile terminal (102).

As illustrated in FIG. 1, the mobile terminals according to the present invention can use the same phone number without requiring a special service from the station.

At least, one of the first mobile terminal (100) and the second mobile terminal (102) can use a rewritable SIM card.

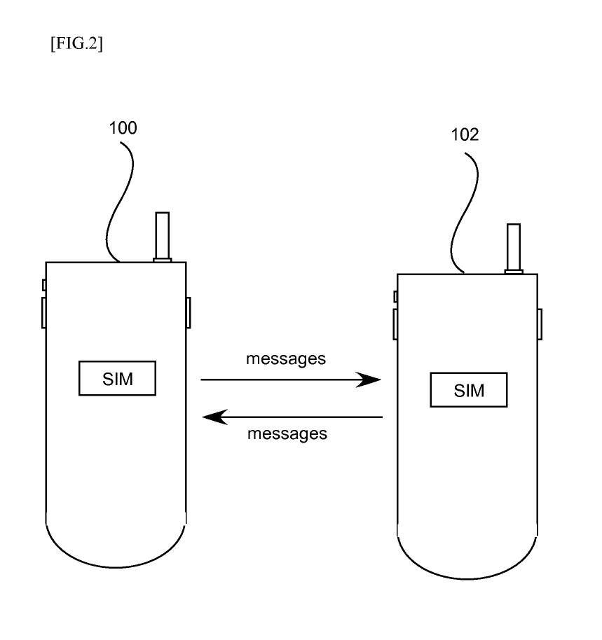

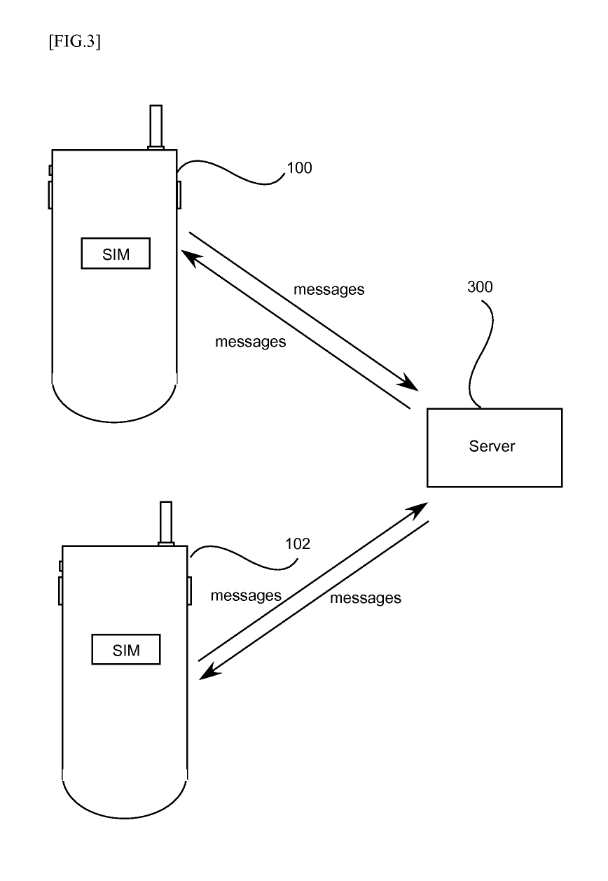

FIG. 2 illustrates message transmission and reception between mobile terminals according to an exemplary embodiment of the present invention and FIG. 3 illustrates message transmission and reception between mobile terminals according to another exemplary embodiment of the present invention.

Since the mobile terminal pair of the present invention first checks the state of the other terminal before activating the SIM card, it is necessary to send and receive state and control messages.

According to FIG. 2, the first mobile terminal (100) and the second mobile terminal (102) send and receive messages directly. The first mobile terminal (100) and the second mobile terminal (102) directly send messages to the paired terminal and it is possible to send and receive messages using Bluetooth, NFC, Wi-Fi, etc. When Wi-Fi is used, various methods such as direct Wi-Fi, internet, intranet, etc. can be used to send and receive data.

Since only one of the two terminals can communicate with the station, it is difficult to send and receive state and control messages through the station.

For example, if the SIM card of the first mobile terminal (100) becomes deactivated, the first mobile terminal (100) sends a state message, which informs the SIM card is deactivated, to the second mobile terminal (102) and the message is sent to the second terminal through Wi-Fi communication, etc.

Referring to FIG. 3, the first mobile terminal (100) and the second mobile terminal (102) can send and receive state and control messages through a server (300).

When the first mobile terminal (100) wishes to send a state message to the second mobile terminal (102), the first mobile terminal (100) transmits the state message to the server (300) and the server (300) transfers the state message to the second mobile terminal (102). This kind of message transmission and reception can be done through various methods such as emails, internet-based text service, etc.

The message transmission and reception method through the server can be used when the first terminal (100) and the second terminal (102) cannot communicate using near field communication methods.

Primarily, as shown in FIG. 3, the state and control messages can be transmitted and received using direct communications. If it is difficult to transmit and receive messages through direct communications, it is possible to transmit and receive them as shown in FIG. 3. In other words, it is possible to transmit and receive messages using communication devices such as Bluetooth, NFC, and direct Wi-Fi, etc.

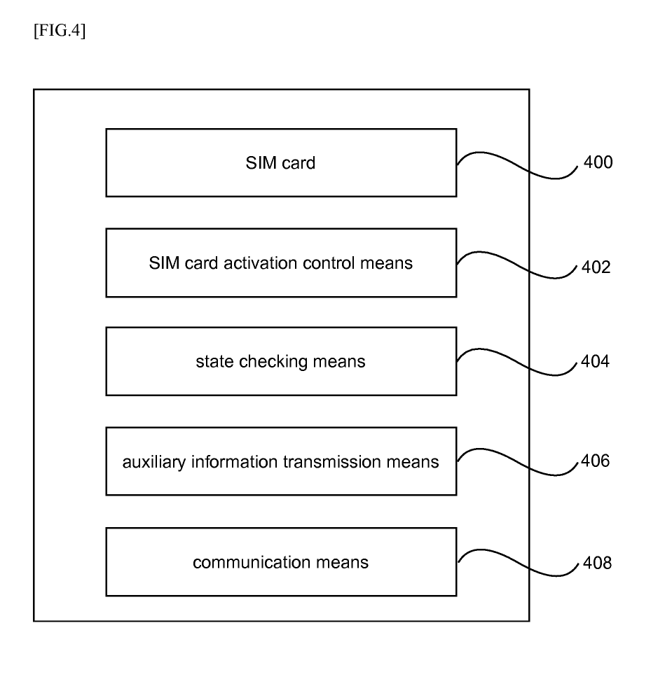

FIG. 4 illustrates the modules of the mobile terminal according to an exemplary embodiment of the present invention.

Referring to FIG. 4, according to an exemplary embodiment of the present invention, the mobile terminal comprises a SIM card (400), SIM card activation control means (402), state checking means, auxiliary information transmission means (406), and communication means (408).

The SIM card (400) is a card for terminal identification, which records identification information. As described previously, conventional SIM cards can be used. Also, a rewritable SIM card can be used.

The SIM card activation control means (402) checks whether the SIM card can be activated and then activates the SIM card. When the SIM card activation control means (402) receives a request for SIM card activation (or power on) through the terminal's interface, it checks whether the paired terminal's SIM card is in an inactive state.

When it is unknown whether the paired terminal's SIM card is in an inactive state, the SIM card activation control means (402) does not activate the SIM card. The SIM card activation control means (402) activates the SIM card only after verifying that the paired terminal's SIM card is in an inactive state.

Although it is not certain whether the paired terminal's SIM card is in an inactive state, it is still possible to forcefully activate the SIM card. For example, when the user carries the second mobile terminal while the first mobile terminal is left at home and is in an active state, the user can ask someone to turn off the first mobile terminal using some communication means such as a wired telephone and then activate the second mobile terminal.

The SIM card activation control means (402) determines the activation of the SIM card using the information stored in the state checking means (404).

The state checking means (404) stores the state information of the paired terminal and the state information can be one of “OFF”, “ON”, and “Unknown”. “OFF” indicates an inactive state, “ON” indicates an active state, and “Unknown” indicates that it is uncertain whether the paired terminal is in an active state or in an inactive state.

The SIM card activation control means (402) activates the SIM card when the state of the paired terminal is in “OFF”, which can be verified from the state checking means (404), while the SIM card activation control means (402) does not activate the SIM card if the state of the paired terminal is in “ON” or “Unknown”. Of course, if it is possible to verify that the paired terminal is in “OFF” using other means, the SIM card can be activated.

The state checking means (404) stores the state information of the paired terminal through the state message sent from the paired terminal. The state checking means (404) sets the state information to “Unknown” when it cannot receive the state information from the paired terminal due to communication interruption.

The auxiliary information transmission means (406) sends stored auxiliary information to the paired terminal. For example, the auxiliary information transmission means (406) sends auxiliary information for the synchronization between terminals when the terminal is going to be turned off (or SIM card is to be deactivated) while the paired terminal is about to be turned on (or the SIM card is to be activated). Here, the auxiliary information includes message information, contact information, and communication history, which are stored in the terminal. However, it is not limited to these, but may include various other types of information stored in the terminal.

The goal for transmitting the auxiliary information is to allow the two terminals to store identical information, which is used by the user. Since it is desirable for the two terminals to store identical communication history, identical messages, identical contact information, etc., each terminal sends auxiliary information to the paired terminal when a certain event occurs.

It is desirable for the auxiliary information transmission means (406) to selectively send only updated information since the last auxiliary information transmission. According to an exemplary embodiment of the present invention, the history of auxiliary information sent to the paired terminal is stored and only the auxiliary information that has not been sent to the paired terminal is transmitted. On the contrary, all auxiliary information can be sent and received.

The communication means (408) performs the task to transmit and receive state request messages, state messages and control messages to and from the paired terminal. The communication means (408) can transmit and receive messages through various communication means such as Wi-Fi, NFC, Bluetooth, etc.

As explained previously, the communication device (408) can directly transmit and receive messages to and from the paired terminal, or transmit and receive messages through servers.

The state request message is a message to request the state of the paired terminal. It is a message informing the state of the terminal, and the control message is a message to control the state change of the paired terminal.

For example, the control message can be a message to deactivate the SIM card of the paired terminal. For instance, when the SIM card of the first mobile terminal is to be activated while the SIM card of the second mobile terminal is in an active mode, the first mobile terminal sends a control message to the second mobile terminal, which requests the second mobile terminal to deactivate its SIM card.

Following the request from the first mobile terminal, the second mobile terminal deactivates its SIM card and transmits a state message to the first mobile terminal, which informs that the SIM card is in “OFF” state. At this moment, the second mobile terminal transmits auxiliary information to the first mobile terminal, which is being activated.

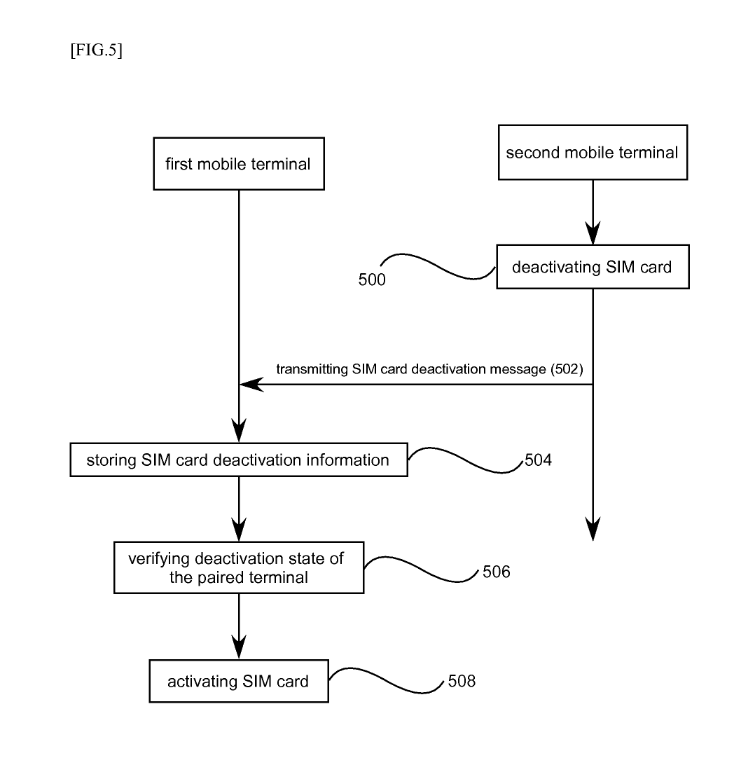

FIG. 5 is a flowchart illustrating how the SIM card of the mobile terminal is activated according to an exemplary embodiment of the present invention.

The exemplary embodiment of FIG. 5 illustrates the activation procedure to activate the SIM card of the first mobile terminal, knowing that the SIM card of the second mobile terminal is in an inactive mode.

Referring to FIG. 5, the second mobile terminal is deactivated or turned off by the user or another type of control (step 500).

When the second mobile terminal is turned off or deactivated, it transmits a state message, which informs that its SIM card is deactivated, to the first mobile terminal (step 502). When the state message is transmitted, the auxiliary information of the second mobile terminal that is being deactivated is also transmitted to the first mobile terminal.

The state checking means of the first mobile terminal stores the state information that asserts that the second mobile terminal, which is the paired terminal is deactivated (step 504). At this moment, the auxiliary information sent by the second mobile terminal can be also stored in a separate memory area.

When it is requested to activate the SIM card of the first mobile terminal by the user or another type of control, the first mobile terminal verifies that the SIM card of the second mobile terminal is in an inactive mode through the state checking means (step 506).

The first mobile terminal, which verifies that the SIM card of the second mobile terminal is in an inactive mode, activates the SIM card of the first mobile terminal and performs communications with the station (step 508).

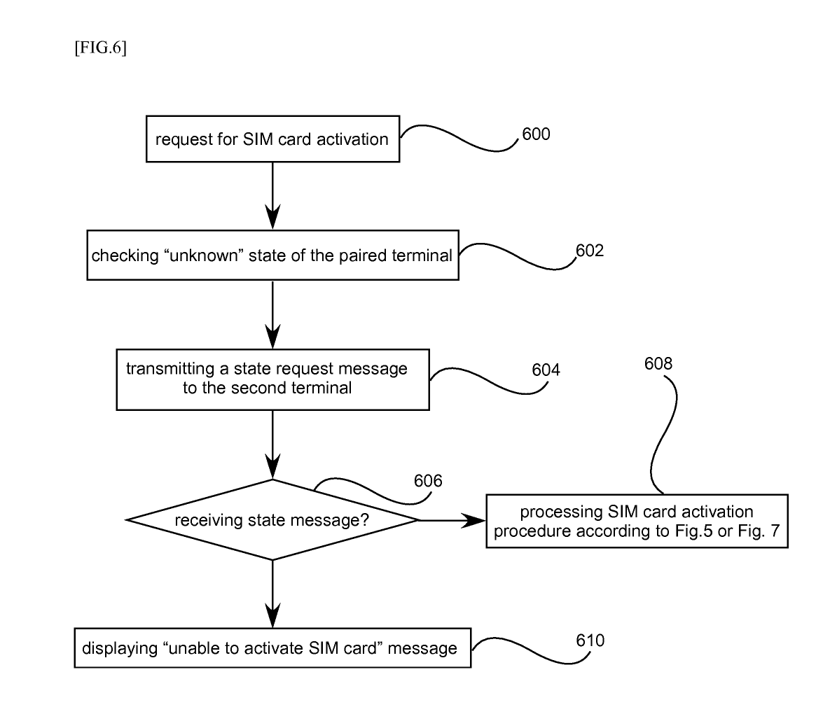

FIG. 6 is a second flowchart which shows how the SIM card of the mobile terminal is activated according to an exemplary embodiment of the present invention.

FIG. 6 illustrates an activation procedure when the first mobile terminal, which is about to activate its SIM card, cannot verify the state of the second mobile terminal.

According to FIG. 6, an action, which activates the SIM card of the first mobile terminal or turns on the first mobile terminal, is requested by the user's operation or another type of control (step 600).

Through the information obtained by the state checking means, the first mobile terminal may find that the state of the second mobile terminal is unknown (step 602). When the state of the paired terminal is “Unknown”, it may be possible that state messages have not been received from the second mobile terminal for a certain period of time. For example, the second mobile terminal sent a state message, but it was not received due to communication problems.

The first mobile terminal transmits a state request message to the second mobile terminal (step 604).

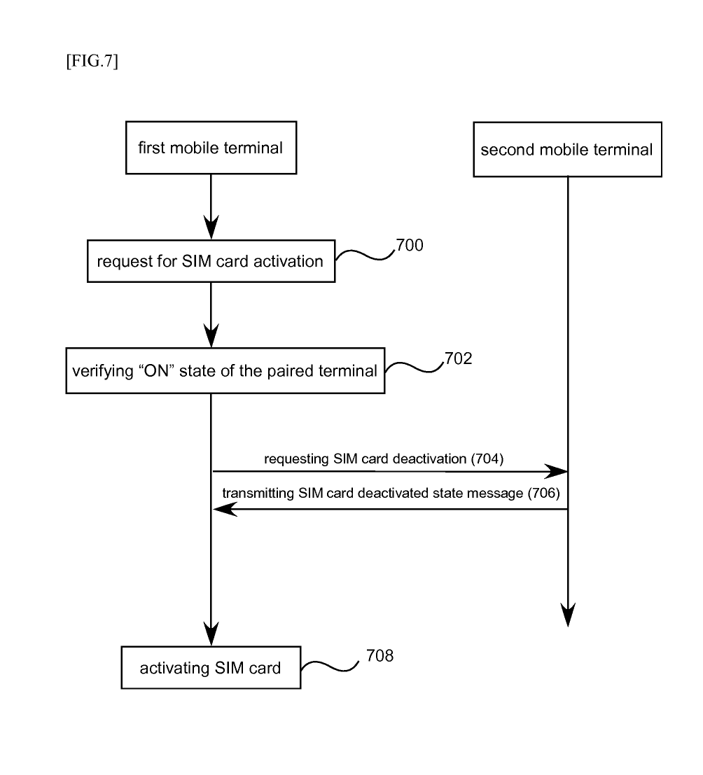

When the state message from the second mobile terminal is received (step 606), either the procedures of FIG. 5 or the procedure of FIG. 7 is conducted depending on whether the state is “ON” or “OFF” (step 608).

When the state of the second mobile terminal is “ON”, the SIM card is activated according to the procedure described in FIG. 7. When the state of the second mobile terminal is “OFF”, the SIM card is activated according to the procedure described in FIG. 5.

When a state message from the second mobile terminal is not received, the first mobile terminal displays a message on the terminal's display, which states the SIM card cannot be activated (step 610).

When communication with the second mobile terminal is not possible, it may be due to the power-off state of the second mobile terminal. In this case, the SIM card of the first mobile terminal can be activated. If the user is aware of this situation, the user may forcefully activate the first mobile terminal and it is desirable to incorporate this forced activation interface into the terminal.

For example, when the second mobile terminal is left at home while the first mobile terminal is taken out, the user may activate the first mobile terminal after calling a family member, using a wired communication and the like, to ask the family member to turn off the second mobile terminal.

FIG. 7 shows a flowchart of the third embodiment showing how the SIM card of the mobile terminal is activated according to an exemplary embodiment of the present invention.

The exemplary embodiment illustrated in FIG. 7 shows the activation procedure for the SIM card when the second mobile terminal, which is the paired terminal, is in “ON” state.

Referring to FIG. 7, a request to activate the SIM card or to perform a power-on operation is made by the user or another type of control (step 700).

Through information obtained by the state checking means, the first mobile terminal confirms that the second mobile terminal, which is the paired terminal, is in an “ON” state (step 702).

The first mobile terminal transmits a control message requesting to deactivate the SIM card to the second mobile terminal (step 704).

The second mobile terminal deactivates the SIM card in accordance with the received control message and transmits a state message notifying that the SIM card is deactivated to the first mobile terminal (step 706).

After the first mobile terminal receives the state message from the second mobile terminal, the first mobile terminal activates its SIM card (step 708).

Due to unexpected situation changes, if communication with the second mobile terminal becomes impossible from being possible, it may not be possible to receive the message notifying the SIM card deactivation from the second mobile terminal due to the communication interruption in step 706.

If the message notifying the SIM card is deactivated from the second mobile terminal cannot be received in step 706, the first mobile terminal may provide an interface that allows the user to choose either to force activation or to abandon activation.

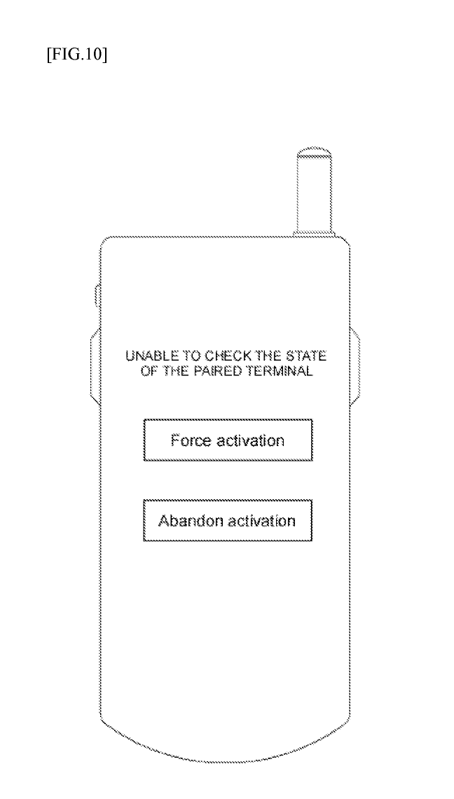

FIG. 10 illustrates an example for the interface that is provided when the first mobile terminal does not receive a message notifying the SIM card is deactivated from the second mobile terminal after sending the message requesting to deactivate the SIM card to the second mobile terminal.

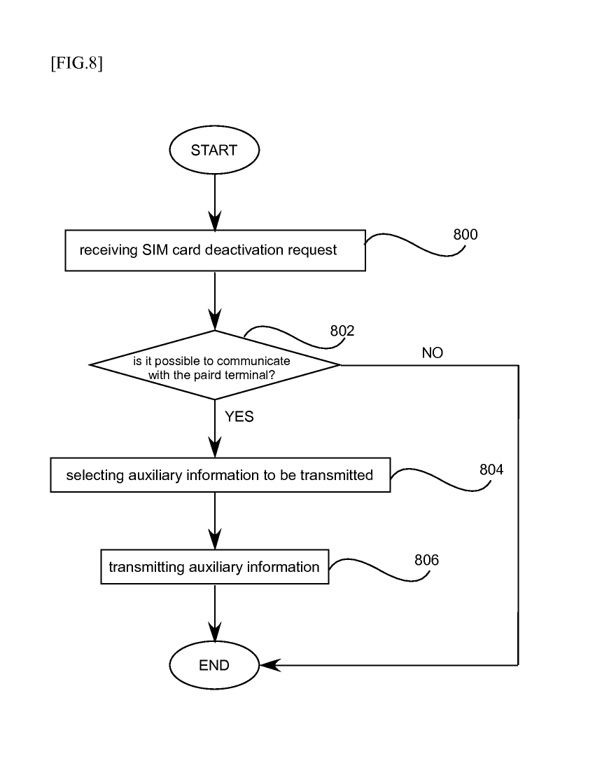

FIG. 8 shows a flowchart that illustrates the procedure to transmit auxiliary information to the paired terminal according to an exemplary embodiment of the present invention.

Referring to FIG. 8, a request to turn off the terminal or deactivate the SIM card can be made by the user operation or another type of control (step 800).

When it is requested to deactivate the SIM card, the terminal checks whether it is possible to communicate with the paired terminal (step 802).

If communication is possible with the paired terminal, the terminal chooses auxiliary information that is to be transmitted to the paired terminal (step 804). As explained previously, the mobile terminal stores the history of auxiliary information transmission and selects only updated auxiliary information.

When the terminal selects auxiliary information, it transmits the selected auxiliary information to the paired terminal (step 806).

Also, it is obvious the those skilled in the art that it is possible to send all auxiliary information for other purposes such as back-up, which is different from the exemplary embodiment of FIG. 8.

The transmission and reception of auxiliary information can be done through a separate medium in addition to a wireless communication link. For example, when the first mobile terminal and the second mobile terminal are connected to the charging device, it is possible to exchange auxiliary information through a charging device.

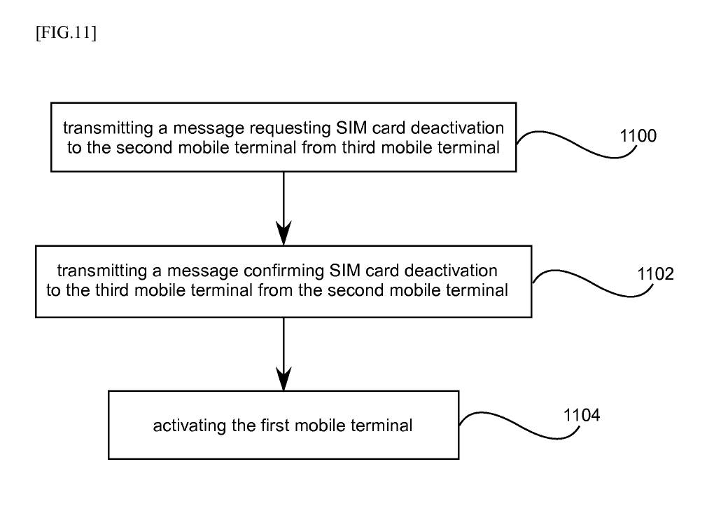

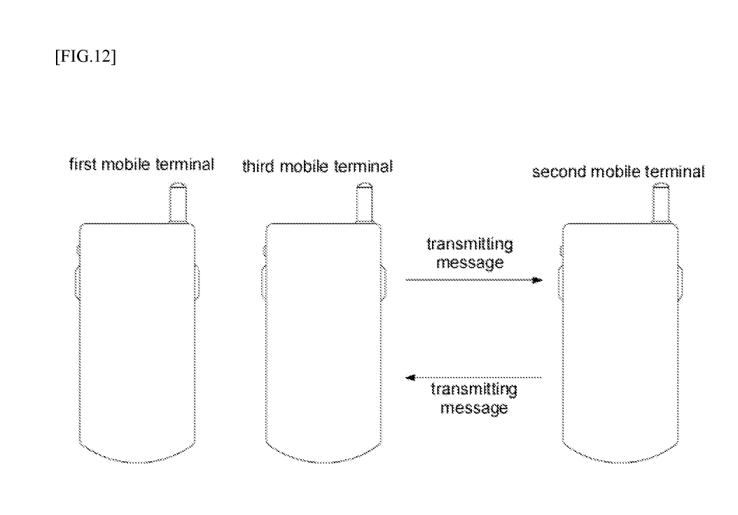

FIG. 11 shows a flowchart for the procedure requesting the second mobile terminal to deactivate its SIM card when the first mobile terminal cannot directly communicate with the second mobile terminal, and FIG. 12 is another illustration of FIG. 11.

Referring to FIGS. 11-12, if direct communication between the first mobile terminal and the second mobile terminal is not possible and it is necessary to deactivate the SIM card of the second mobile terminal, a message requesting to deactivate the SIM card is transmitted to the second mobile terminal through a third terminal, which is another terminal. The message is transmitted using a text message service (step 1100).

According to the exemplary embodiment of the present invention, it is desirable for the text message, which is transmitted to the second mobile terminal, requesting to deactivate the SIM card from the third mobile terminal, to include a predetermined password.

The second mobile terminal receives the text message with a predetermined password from the third mobile terminal and confirms the request to deactivate the SIM card through the text message. The second mobile terminal transmits a text message confirming that its SIM card is deactivated to the third mobile terminal and then deactivates its SIM card (step 1102). The text message from the second mobile terminal to the third mobile terminal may also contain a predetermined password.

When the reception of the SIM card deactivation message is verified from the third mobile terminal, the user activates the SIM card of the first mobile terminal (step 1104).

Although FIG. 11 explains a case where controlling SIM card activation is performed using the third mobile terminal that is another mobile terminal, it is obvious to the those skilled in the art that the SIM card activation control can be done using a computer, a notebook, etc. instead of a mobile terminal.

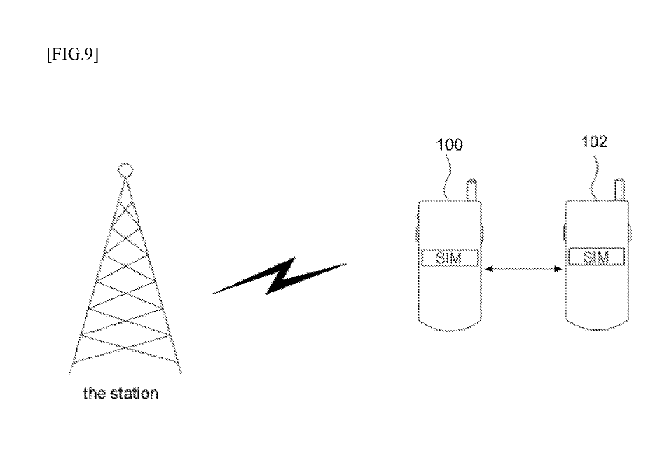

FIG. 9 shows an example where the mobile terminal and the paired mobile terminal use the station link according to the exemplary embodiment of the present invention.

Among the two terminals shown in FIG. 9, the first mobile terminal (100) has an activated SIM card and can communicate with the station while the second mobile terminal (102) with a deactivated SIM card cannot communicate with the station.

If the first mobile terminal (100) is a smartphone and the second mobile terminal is a tablet PC, the second mobile terminal can be set to use the wireless link of the first mobile terminal (100).

A tablet PC can use the wireless link to station through direct communications (Wi-Fi, Bluetooth, etc.) with the first mobile terminal (100).

As shown in FIG. 9, a set of two terminals can be provided to the user as a terminal pair. In other words, a terminal is set to share the wireless link with the paired terminal and a set of two terminals with identical SIM cards can be provided to the user as a single item.

The user may selectively use one of the two terminals and it is possible for the terminal with a deactivated SIM card to communicate with the station by sharing the wireless link between the paired terminal and the station.

In the above, mobile terminals with controllable SIM cards and control methods thereof are described. As explained, such mobile terminals can be manufactured at the factory in accordance with the descriptions. Alternatively, separate applications that perform the described control methods can be installed. Therefore, such applications developed to perform the terminal control methods described in the above can be included in the present invention.

As described above, the exemplary embodiments with specific elements have been described and illustrated with the drawings and the specifications, but these exemplary embodiments were chosen and described in order to help general understanding of the present invention. The present invention is not limited to the aforementioned embodiment and thereby others skilled in the art can make and utilize various exemplary embodiments of the present invention, as well as various alternatives and modifications thereof. Therefore, the teaching and ideas of the present invention are not limited by the aforementioned embodiments, and the following claims and equivalents to the claims and all equivalent modifications to the claims should be considered to be covered by the present invention.

What is claimed is:

1. A terminal which is paired with a second terminal, comprising:
a first SIM card;
state checking means which checks the state of the paired terminal with a second SIM card with identical identification information as the first SIM card; and
SIM card activation control means which activates the first SIM card depending on the state of the paired terminal.

2. The terminal of claim 1, wherein the SIM card activation control means activates the first SIM card when the second SIM card of the paired terminal is deactivated.

3. The terminal of claim 1, further comprising:
communication means which transmits and receives messages to and from the paired terminal.

4. The terminal of claim 1, further comprising:
auxiliary information transmission means that transmits auxiliary information, which is stored, to the paired terminal.

5. The terminal of claim 3, wherein the communication means transmits a SIM card deactivation control message to the paired terminal when the second SIM card of the paired terminal is in an active state, the state checking means verifies that the second SIM card of the paired terminal is deactivated, and then the SIM card activation control means activates the first SIM card.

6. The terminal of claim 3, wherein the communication means transmits a state report request message to the paired terminal when the state of the paired terminal is unknown.

7. The terminal of claim 4, wherein the auxiliary information transmission means that transmits auxiliary information to the paired terminal when the terminal is to be turned off or the first SIM is to be deactivated stores the history of auxiliary information transmission, selects some auxiliary information which was not transmitted, and transmits the selected auxiliary information.

8. The terminal of claim 3, wherein the communication means transmits a state message about SIM card deactivation to the paired terminal when a SIM card deactivation control message or a power-off control message is received.

9. The terminal of claim 3, wherein the communication means transmits a message to a server which can transfer the message to the paired terminal.

10. The terminal of claim 1, wherein the first SIM card is a rewritable SIM card and specific received SIM card identification information is recorded to the rewritable SIM card.

11. The terminal of claim 1, wherein the terminal reads SIM card identification information and transmits the SIM card identification information to the paired terminal.

12. A terminal control method for a terminal with a first SIM card and a paired terminal with a second SIM card which is paired with the first terminal, comprising:
(a) checking the state of the paired terminal with the identical SIM card identification information;
(b) controlling the activation of the SIM card depending on the state of the paired terminal.

13. The method of claim 12, wherein the step (b) activates the first SIM card when the second SIM card of the paired terminal is deactivated.

14. The method of claim 12, further comprising:
(c) transmitting and receiving messages to and from the paired terminal.

15. The method of claim 12, further comprising:
(d) transmitting auxiliary information stored in the terminal to the paired terminal.

16. The method of claim 14, wherein the step (c) transmits a SIM card deactivation control message to the paired terminal when the SIM card of the paired terminal is in an active state.

17. The method of claim 14, wherein the step (c) transmits a state report request message to the paired terminal when the state of the paired terminal is unknown.

18. The method of claim 15, wherein the step (d) selects some auxiliary information which was not transmitted to the paired terminal and transmits the selected auxiliary information.

19. The method of claim 14, wherein the step (c) transmits a state message about SIM card deactivation when a SIM card deactivation or power-off control message is received.

20. The method of claim 12, further comprising:
(e) storing programs to perform one of the methods, wherein the programs can be read by a digital processing apparatus.

21. A terminal set, comprising:
a first terminal with a first SIM card;
a second terminal which has a second SIM card with identical identification information as the first SIM card and activates the second SIM card depending on the state of the first SIM card of the first terminal.

22. The terminal of claim 21, wherein the first terminal activates the first SIM card depending on the state of the second SIM card of the second terminal.

23. The terminal of claim 21, wherein the second terminal communicates with a station through the first terminal when the first SIM card of the first terminal is in an activated state while the second SIM card of the second terminal is in a deactivated state.
